(19) United States
(12) Patent Application Publication
(10) Pub. No.: US 2010/0079669 A1
(43) Pub. Date: Apr. 1, 2010

(54) IMAGE DISPLAY APPARATUS AND IMAGE DISPLAY METHOD

(76) Inventors: Hideharu Hattori, Kawasaki (JP); Koichi Hamada, Yokohama (JP); Nobuhiro Fukuda, Tokyo (JP); Mitsuo Nakajima, Yokohama (JP)

Correspondence Address: MCDERMOTT WILL & EMERY LLP, 600 13TH STREET, N.W., WASHINGTON, DC, 20005-3096, US

(21) Appl. No.: 12/478,543

(22) Filed: Jun. 4, 2009

(30) Foreign Application Priority Data
Sep. 26, 2008 (JP) 2008-247968

(51) Int. Cl. G06T 1/00; H04N 5/04

(52) U.S. Cl. 348/500; 345/522; 348/E05.009

(57) ABSTRACT

A sub-field lighting image display apparatus according to the present invention improves a dynamic false contour, motion judder, and the like occurring when displaying an image to which frame rate conversion is applied. A frame rate conversion section converts a frame rate for an input image. A motion vector detection section detects motion vector V0 between frames in the input image and finds motion vector V after the frame rate conversion based on the detected motion vector V0. When the frame rate conversion section repeatedly outputs the input image as an interpolation image, a motion vector correction section corrects the motion vector V to V1 using V1=V×α, where 0≦α<1. A sub-field conversion section converts each frame into luminescent data for multiple sub-fields. A sub-field correction section relocates the luminescent data for the sub-fields using the corrected motion vector V1.

### CLAIM OF PRIORITY

The present application claims priority from Japanese patent application serial No. JP 2008-247968, filed on Sep. 26, 2008, the content of which is hereby incorporated by reference into this application.

### BACKGROUND OF THE INVENTION

(1) Field of the Invention

The present invention relates to a sub-field lighting image display apparatus and an image display method for gradation display by time-sharing each of image frames created by frame rate conversion into multiple sub-fields.

(2) Description of the Related Art

Frame rate conversion (frame count conversion) is needed when the frame rate of an input image signal differs from the display frame rate of an image display apparatus. The frame rate conversion preferably interpolates frames so that the image quality is prevented from degrading and an image continues to move smoothly between frames. A motion correcting frame count conversion method generates an interpolation frame signal by moving image positions of contiguous frames along a motion vector. The motion correcting frame count conversion method is considered to effectively eliminate motion judder from a moving image.

Japanese Published Unexamined Patent Application No. Hei 11-112939 discloses a technology that finds a pixel-based motion vector and creates an interpolation frame based on that motion vector. The technology aims at preventing the motion correcting frame count conversion method from causing local degradation such as partially replacing the same object with another image or from causing resolution degradation such as flickering at the peripheral edge of a moving image or an unnaturally rendered motion.

An image display apparatus using a plasma display panel (PDP), for example, employs the sub-field lighting gradation display system (halftone display system). The gradation display system divides one frame or field into multiple screens or sub-fields (SFs) having different intensity weights along the time direction and controls whether or not to light each sub-field. When a moving image is displayed, the gradation display system is subject to a problem of dynamic false contour that disturbs gradations or a problem of moving image blur to degrade the display quality. It is known that the dynamic false contour and moving image blur occurs when a human eye follows a moving object.

To prevent the dynamic false contour from occurring, Japanese Published Unexamined Patent Application No. Hei 8-211848 discloses a sub-field (SF) correction technology. The technology detects a motion vector of each pixel between frames or fields and aligns luminescent positions of the sub-fields for display pixels to pixel positions for the sub-fields along a direction calculated from the motion vector.

### SUMMARY OF THE INVENTION

When the input image frame rate differs from the display frame rate, the frame rate conversion is used to create a frame to be interpolated according to the following methods. One is to newly create an interpolation frame using a motion vector. Another is to repeatedly output an input frame as an interpolation frame as is. Throughout the specification, the former is referred to as a “frame rate conversion ON” state and the latter as a “frame rate conversion OFF” state. Basically, the frame rate conversion ON state may be always used to output interpolation frames. Depending on image patterns or degrees of motion, however, the frame rate conversion OFF state may less degrade the image quality than the frame rate conversion ON state when an image is displayed. It is a general practice to appropriately switch between the frame rate conversion ON and OFF states and output interpolation frames to a display apparatus.

However, the following problem was found when the frame rate conversion ON/OFF state is simply combined with the sub-field correction on the display apparatus.

The frame rate conversion technology described in Japanese Published Unexamined Patent Application No. Hei 11-112939 reduces the motion judder and generates less blurred moving images. However, let us consider that a sub-field lighting display apparatus (PDP) displays an image in the frame rate conversion ON state as is without sub-field correction. The image causes a dynamic false contour that was invisible due to the moving image blur.

The sub-field correction technology described in Japanese Published Unexamined Patent Application No. Hei 8-211848 reduces the dynamic false contour from images when the frame rate conversion is turned on. However, the inventors found that the motion judder is emphasized when the frame rate conversion is turned off and that an image oscillates when the frame rate conversion is turned on from the off state, or vice versa.

The present invention has been made in consideration of the foregoing. It is therefore an object of the present invention to improve a dynamic false contour, motion judder, image oscillation, or moving image blur occurring when a sub-field lighting image display apparatus displays an image to which frame rate conversion is applied.

According to the present invention, there is provided an image display apparatus that time-shares an image frame created by frame rate conversion into a plurality of sub-fields and displays luminescent data in the sub-fields. The image display apparatus includes: a motion vector detection section that detects motion vector V0 for a pixel between frames of an input image and finds motion vector V for a pixel between frames whose frame rates are converted using the motion vector V0; a frame rate conversion section that converts a frame rate for the input image into a frame rate for image display using a first conversion mode or a second conversion mode, wherein the first conversion mode creates an interpolation image using the motion vector V0 or V and the second conversion mode repeatedly outputs the input image; a sub-field conversion section that converts each frame of an image having the converted frame rate into luminescent data for the plurality of sub-fields; a changeover detection section that detects one of the first and second conversion modes performed by the frame rate conversion section; a motion vector correction section that corrects a motion vector V found by the motion vector detection section to a motion vector V1 in accordance with a conversion mode detected by the changeover detection section; a sub-field correction section that relocates luminescent data for the sub-fields converted by the sub-field conversion section using the corrected motion vector V1; and an image display section that displays an image using the luminescent data for the sub-fields relocated by the sub-field correction section. The motion vector correction section assumes the motion vector V to be the corrected motion vector V1 as is when the changeover detection section detects the first conversion mode. The motion vector correction section corrects a motion vector according to V1=V×α, where 0≦α<1, when the changeover detection section detects the second conversion mode.

The changeover detection section further detects whether there is a change between the first conversion mode and the second conversion mode performed by the frame rate conversion section. When the changeover detection section detects a conversion mode change, the motion vector correction section corrects a motion vector for an image corresponding to the conversion mode change using V1=V×(1−β)+(V×α)×β, where 0<β<1.

According to the invention, there is provided an image display method of time-sharing an image frame created by frame rate conversion into a plurality of sub-fields and displaying luminescent data in the sub-fields. The image display method includes the steps of: (a) detecting motion vector V0 for a pixel between frames of an input image and finds motion vector V for a pixel between frames whose frame rates are converted using the motion vector V0; (b) converting a frame rate for the input image into a frame rate for image display using a first conversion mode or a second conversion mode, wherein the first conversion mode creates an interpolation image using the motion vector V0 or V and the second conversion mode repeatedly outputs the input image; (c) converting each frame of an image having the converted frame rate into luminescent data for the plurality of sub-fields; (d) detecting one of the first and second conversion modes performed at the step (b); (e) correcting a motion vector V found at the step (a) to a motion vector V1 in accordance with a conversion mode detected at the step (d); (f) relocating luminescent data for the sub-fields converted at the step (c) using the corrected motion vector V1; and (g) displaying an image using the luminescent data for the sub-fields relocated at the step (f). The step (e) assumes the motion vector V to be the corrected motion vector V1 as is when the step (d) detects the first conversion mode. The step (e) corrects a motion vector according to V1=V×α, where 0≦α<1, when the step (d) detects the second conversion mode.

The step (d) further detects whether there is a change between the first conversion mode and the second conversion mode performed at the step (b). When the step (d) detects a conversion mode change, the step (e) corrects a motion vector for an image corresponding to the conversion mode change using V1=V×(1−β)+(V×α)×where 0<β<1.

According to the invention, a sub-field lighting image display apparatus is capable of displaying a frame-rate converted image by reducing a dynamic false contour, motion judder, image oscillation, or moving image blur and providing a high-quality image that reduces image degradation.

### BRIEF DESCRIPTION OF THE DRAWINGS

These and other features, objects and advantages of the present invention will become more apparent from the following description when taken in conjunction with the accompanying drawings wherein:

FIG. 1 is a block diagram showing the image display apparatus according to a first embodiment of the invention (first embodiment);

FIGS. 2A and 2B exemplarily show operations of a frame rate conversion section 12;

FIG. 3 is a flow chart showing operations of a changeover detection section 14;

FIG. 4 is a flow chart showing operations of a motion vector correction section 15;

FIG. 5 is a flow chart showing operations of a sub-field correction section 16;

FIGS. 6A, 6B, and 6C show examples of sub-field correction;

FIG. 7 is a flow chart showing an operation of the motion vector correction section 15 according to a second embodiment of the invention (second embodiment);

FIG. 8 shows an example of the sub-field correction;

FIG. 9 is a block diagram showing the image display apparatus according to a third embodiment of the invention (third embodiment);

FIG. 10 is a flow chart showing an operation of the motion vector correction section 15 according to the third embodiment;

FIG. 11 is a block diagram showing the image display apparatus according to a fourth embodiment of the invention (fourth embodiment); and

FIG. 12 is a flow chart showing an operation of the motion vector correction section 15 according to the fourth embodiment.

### DETAILED DESCRIPTION OF THE EMBODIMENT

Embodiments of the present invention will be described in further detail with reference to the accompanying drawings. Throughout the drawing, the same elements when shown in more than one figure are designated by the same reference numerals. In the description to follow, the term “sub-field” covers the meaning of “sub-field period.” The term “sub-field lighting” covers the meaning of “pixel lighting during a sub-field period.” In the description or drawing to follow, just the scalar quantity as a motion vector value is equivalent to pixel-based representation of the horizontal motion quantity in a two-dimensional vector. For example, simply representing “+4” is equivalent to horizontal motion vector Vx=+4.

### First Embodiment

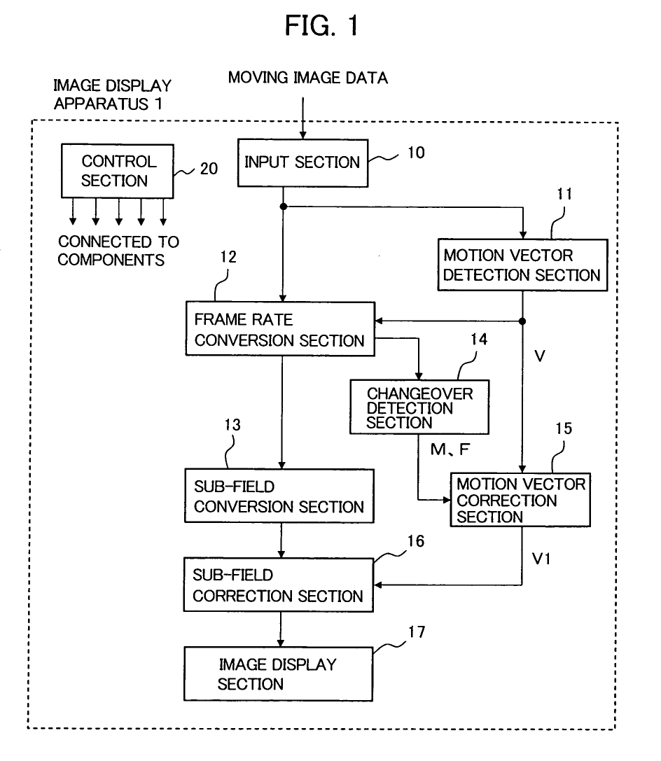

FIG. 1 is a block diagram showing the image display apparatus according to the first embodiment of the invention. An image display apparatus 1 includes an input section 10, a motion vector detection section 11, a frame rate conversion section 12, a sub-field conversion section 13, a changeover detection section 14, a motion vector correction section 15, a sub-field correction section 16, an image display section 17, and a control section 20.

The following describes the operation of each of the above sections. The input section 10 is supplied with moving image data. For example, the input section 10 may include an image input terminal or a network connection terminal or may include a TV broadcasting tuner. The input section 10 applies image preprocessing to the input moving image data as needed. The input section 10 outputs the processed display data to the motion vector detection section 11 and the frame rate conversion section 12.

The motion vector detection section 11 detects a motion vector V0 for a pixel between frames of the input image. The motion vector detection section 11 finds a motion vector V for each pixel between frames whose frame rate is converted through the use of the motion vector V0. These motion vectors are used to find information about the speed and the direction of an object. The motion vector V of a given pixel is represented as V=(Vx,Vy), where Vx denotes a horizontal component of the motion vector V and Vy denotes a vertical component thereof. Existing technologies used for MPEG encoding processes are applicable as technologies of detecting or estimating motions for detecting a motion vector and so a description is omitted for simplicity.

The frame rate conversion section 12 converts a frame rate of moving image data to be input into a frame rate for display. The frame rate conversion section 12 increases a frame rate by inserting one or more interpolation frames between the current frame and a preceding frame, i.e., a frame immediately preceding the current frame. In this case, the frame rate conversion section 12 compares image data for the preceding frame with image data for the current frame and creates an interpolation frame using the motion vector V0 or V found by the motion vector detection section 11 so as to smooth a motion between frames. This state is hereafter referred to as frame rate conversion ON (first conversion mode). By contrast, image data for the preceding frame may be repeatedly used as is without creating a new frame as an interpolation frame. This state is hereafter referred to as frame rate conversion OFF (second conversion mode). The control section 20 issues an instruction to switch between the frame rate conversion states ON and OFF depending on image contents or an image pattern.

The sub-field conversion section 13 converts pixel data of the input image into luminescent data of the sub-fields. One frame is divided into N sub-fields. Brightness of the sub-fields are weighted like 2 to the 0th power, to the first power, . . . , and to the (N-1)th power, for example. The sub-field conversion section 13 selects whether or not the sub-fields are luminous. The sub-field conversion section 13 represents the gradation of the frame in terms of the sum of brightness corresponding to luminous sub-fields.

The changeover detection section 14 detects a display mode M for image data outputted from the frame rate conversion section 12 and a changeover flag F indicating a changeover state (conversion mode) of the frame rate conversion. The display mode M represents the number of display frame updates in terms of 24 Hz, 50 Hz, or 60 Hz, for example. Let us suppose that the display frame rate is 60 Hz and the input frame rate is 24 Hz for repeatedly displaying the same frame. In this case, the number of updates is 24 Hz. The changeover flag F indicates transition of the frame rate conversion mode ON or OFF between the preceding frame and the current frame. The changeover flag F is defined to take four values: 1 for change from ON to ON; 2 for change from OFF to OFF; 3 for change from ON to OFF; and 4 for change from OFF to ON.

The motion vector correction section 15 corrects the motion vector V detected by the motion vector detection section 11 to a motion vector V1 depending on states of the display mode M and the changeover flag F detected by the changeover detection section 14. The correction method will be described later. For example, let us suppose that the changeover flag F is set to 2 or 3. This means that the current frame enters the second conversion mode. In such case, the motion vector V is multiplied by attenuation coefficient a and is corrected to the motion vector V1.

The sub-field correction section 16 relocates luminescent data found by the sub-field conversion section 13 for sub-fields of each pixel using the motion vector V1 that is corrected by the motion vector correction section 15 for each pixel. Luminescent data is relocated on a pixel basis in a direction indicated by the motion vector V1. The sub-field correction section 16 repeats this operation for all the pixels in the frame to relocate sub-field data outputted from the sub-field conversion section 13.

The display section 17 includes a display device such as a PDP having multiple pixels that perform lighting operations such as turning on and off. The image display section 17 controls the lighting operations of pixels based on the sub-field data relocated by the sub-field correction section 16 so as to display images.

The control section 20 is connected to various components in the display apparatus. The components of the display apparatus operate autonomously as mentioned above or in accordance with instructions from the control section 20.

The image display apparatus 1 according to the embodiment corrects a motion vector using the display mode M and the changeover flag F detected by the changeover detection section 14. Using the corrected motion vector, the image display apparatus 1 corrects sub-fields of the image data outputted from the frame rate conversion section 12.

The following describes in more detail the configurations and operations of the components.

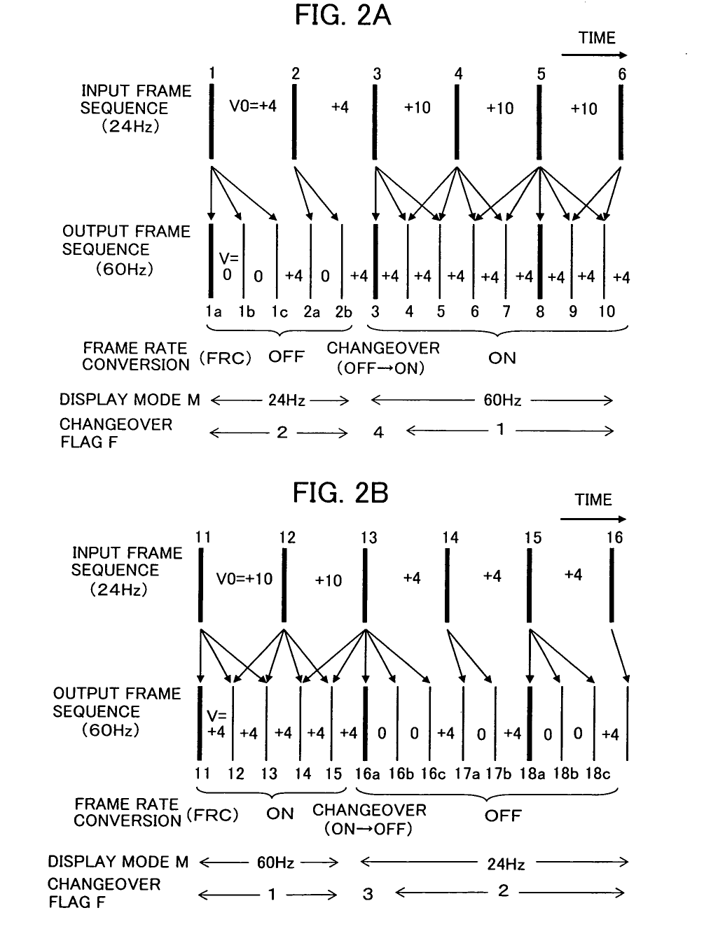

FIGS. 2A and 2B exemplarily show operations of the frame rate conversion section 12. The example shows frame rate conversion (FRC) of a frame sequence (frame rate 24 Hz) of input moving image data into an output frame sequence (display frame rate 60 Hz). FIG. 2A changes the FRC from OFF to ON. FIG. 2B changes the FRC from ON to OFF. Frames are numbered chronologically. The motion vector V0 between input frames is set to two values +4 and +10 for simplicity. When V0 is set to +4, an image motion is small and the FRC is turned off. When V0 is set to +10, an image motion is large and the FRC is turned on.

In FIG. 2A, the FRC turns off for input frames 1 and 2 and repeatedly outputs the input frames unchanged at an interval of 60 Hz. That is, the frame rate conversion section 12 creates output frames 1a, 1b, 1c, 2a, and 2b. The motion vector V is set to 0 between output frames 1a and 1b and output frames 1b and 1c. The motion vector V is set to +4 between frames 1c and 2a that are updated. Similarly, the motion vector V is set to 0 between frames 2a and 2b and is set to +4 between frames 2b and 3.

The FRC turns on for input frames 3 through 6. The frame rate conversion section 12 creates and outputs interpolation frames at an interval of 60 Hz. For example, the frame rate conversion section 12 creates output interpolation frames 4 and 5 from input frames 3 and 4 and creates output interpolation frames 6 and 7 from input frames 4 and 5. When the linear interpolation is performed, the motion vector V is set to +4 between the output frames 3 and 4 and between output frames 4 and 5.

The display mode M is set to 24 Hz for output frames 1a through 2b and set to 60 Hz for output frames 3 through 10. The changeover flag F is set to 2 (OFF unchanged) for output frames 1a through 2b, set to 4 (changed from OFF to ON) for output frame 3, and set to 1 (ON unchanged) for output frames 4 through 10.

In FIG. 2B, the FRC turns on for input frames 11 and 12 and turns off for input frames 13 through 16. The frame rate conversion section 12 creates interpolation frames similarly to FIG. 2A. The motion vector V is set to +4 between output frames 11 through 16a, set to 0 between output frames 16a and 16b and between output frames 16b and 16c, and set to +4 between output frames 16c and 17a.

The display mode M is set to 60 Hz for output frames 11 through 15 and set to 24 Hz for output frames 16a through 18c. The changeover flag F is set to 1 (ON unchanged) for output frames 11 through 15, set to 3 (changed from ON to OFF) for output frame 16a, and set to 2 (OFF unchanged) for output frames 16b through 18c.

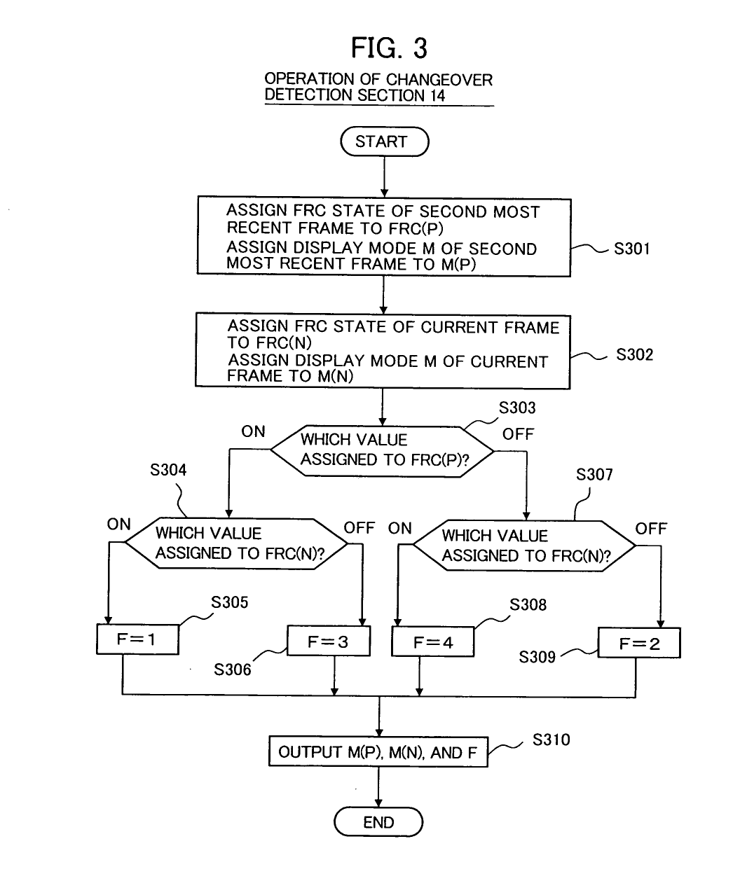

FIG. 3 is a flow chart showing operations of the changeover detection section 14.

The changeover detection section 14 detects the display mode M and the changeover flag F from image frames outputted from the frame rate conversion section 12 and outputs the display mode M and the changeover flag F. The process is described below.

At S301, the changeover detection section 14 detects the FRC state (ON or OFF) of the second most recent output frame and assumes the state to be FRC(P). The changeover detection section 14 detects the display mode M of the second most recent frame and assumes the display mode M to be M(P). At S302, the changeover detection section 14 detects the FRC state of the current frame and assumes the state to be FRC(N). The changeover detection section 14 detects the display mode M of the current frame and assumes the display mode M to be M(N).

At S303, the changeover detection section 14 determines whether FRC(P) is turned ON or OFF. When FRC(P) is turned ON, the changeover detection section 14 proceeds to S304 and determines whether FRC(N) is turned ON or OFF. When FRC(N) is turned ON, the changeover detection section 14 proceeds to S305 and sets the changeover flag F to 1 (ON unchanged). When FRC(N) is turned OFF, the changeover detection section 14 proceeds to S306 and sets the changeover flag F to 3 (changing from ON to OFF).

When FRC(P) is turned OFF at S303, the changeover detection section 14 proceeds to S307 and determines whether FRC(N) is turned ON or OFF. When FRC(N) is turned ON, the changeover detection section 14 proceeds to S308 and sets the changeover flag F to 4 (changing from OFF to ON). When FRC(N) is turned OFF, the changeover detection section 14 proceeds to S309 and sets the changeover flag F to 2 (OFF unchanged).

At S310, the changeover detection section 14 outputs the detected display modes M(P) and M(N) and the changeover flag F to the motion vector correction section 15. In FIG. 2A, for example, the changeover detection section 14 detects and outputs M(P)=24 Hz, M(N)=60 Hz, and F=4 (changing from OFF to ON) with respect to the output frame 3.

The motion vector correction section 15 is described below. When the FRC is turned OFF (second conversion mode), the frame rate conversion section 12 repeatedly displays an input frame. In FIG. 2A, for example, the frame rate conversion section 12 repeatedly displays 24 Hz input frame 1 or 2 and displays the frame as 60 Hz output frames 1a, 1b, 1c, 2a, and 2b. This video is subject to sub-field correction in the sub-field correction section 16 and is displayed on the image display section 17. The displayed video emphasizes motion judder. The reason follows. The frame rate conversion section 12 turns off the FRC to lose smoothness of an image motion between the output frames. The motion concentrates between specific frames (1c and 2a), thus causing the motion judder. The sub-field correction section 16 performs the sub-field correction to further accelerate the motion. Consequently, the motion judder is emphasized.

To prevent the sub-field correction, the motion vector correction section 15 performs correction for decreasing the size of the motion vector V. Specifically, the following equation (1) is used to multiply the motion vector V by attenuation coefficient a to find the motion vector V1.

V1=V×α (1)

An optimal value is selected for attenuation coefficient a from the range 0≦α<1 in accordance with the image quality. This makes it possible to alleviate a rapid image motion and prevent the motion judder from being emphasized.

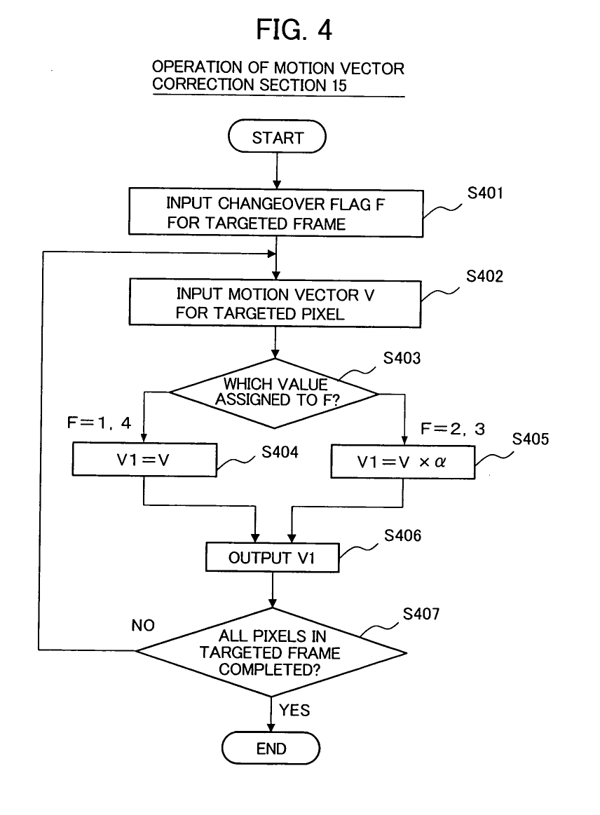

FIG. 4 is a flow chart showing operations of the motion vector correction section 15.

At S401, the motion vector correction section 15 is supplied with the changeover flag F found by the changeover detection section 14 for the targeted frame. At S402, the motion vector correction section 15 is supplied with the motion vector V found by the motion vector detection section 11 for the targeted pixel. At S403, the motion vector correction section 15 determines the value of the changeover flag F.

The changeover flag F set to 1 or 4 denotes that the FRC is turned on for the targeted frame and the first conversion mode is enabled. In this case, the motion vector correction section 15 proceeds to S404 and assumes the correction vector V1 to be V and does not correct the motion vector. The changeover flag F set to 2 or 3 denotes that the FRC is turned off for the targeted frame and the second conversion mode is enabled. In this case, the motion vector correction section 15 proceeds to S405 and finds a new motion vector V1 using the equation (1).

At S406, the motion vector correction section 15 outputs the corrected motion vector V1 to the sub-field correction section 16. The motion vector correction section 15 proceeds to S407 and repeats S402 through S406 until all the pixels in the targeted frame are corrected.

As mentioned above, the motion vector correction section 15 according to the embodiment performs the correction so as to decrease the motion vector of each pixel in the frame to be output when the changeover flag F for the targeted frame is set to 2 or 3 to turn off the frame rate conversion FRC.

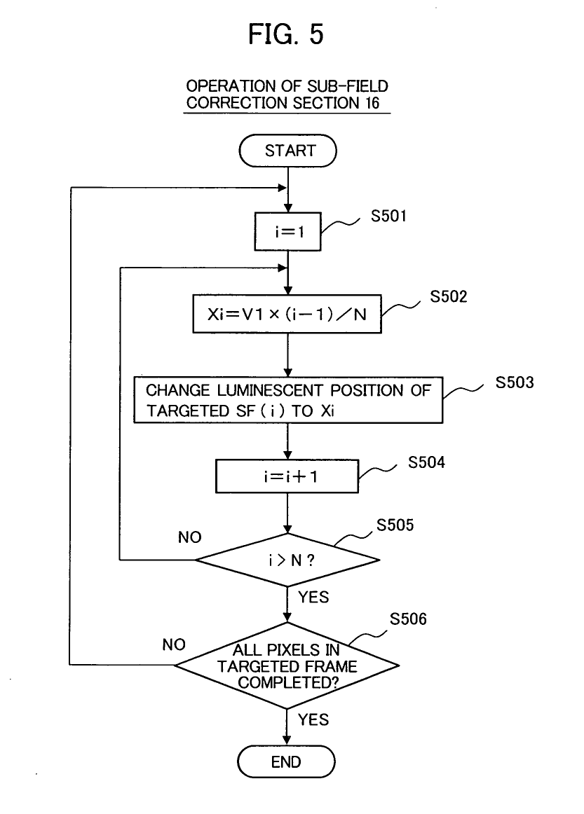

FIG. 5 is a flow chart showing operations of the sub-field correction section 16. The sub-field correction section 16 relocates sub-field data found by the sub-field conversion section 13. The sub-field correction section 16 determines a relocation position using the corrected motion vector V1 found by the motion vector correction section 15. The following description assumes that N denotes the total number of sub-fields (SFs) and variable i (i=1 through N) denotes a number assigned to each SF.

At S501, the sub-field correction section 16 assigns 1 to variable i. At S502, the sub-field correction section 16 calculates the following to find pixel position Xi to which sub-field data is to be moved.

Xi=V1×(i−1)/N (2)

The calculation uses the corrected value V1 as a motion vector. The sub-field correction section 16 assumes Xi=0 for i=1 (beginning SF) and does not move the pixel position. At S503, the sub-field correction section 16 relocates the luminescent position of targeted SF(i) to the position corresponding to the pixel position Xi.

At S504, the sub-field correction section 16 adds 1 to i to find number i for a next targeted SF. At S505, the sub-field correction section 16 determines i>N, namely, whether or not all SFs for the targeted pixel have been relocated. When the determination is negative, the sub-field correction section 16 repeats S502 to S504. When the determination is affirmative, the sub-field correction section 16 proceeds to S506 and repeats S501 to S505 until SFs for all the pixels in the targeted frame are relocated. In this manner, the sub-field correction section 16 uses the corrected motion vector V1 to relocate SFs for all the pixels in the targeted frame found by the sub-field conversion section 13.

The pixel position Xi calculated at S502 may result in decimal accuracy. The result may be rounded off, down, or up to use integer accuracy for the pixel position Xi. The following embodiments use integer accuracy by rounding down the result.

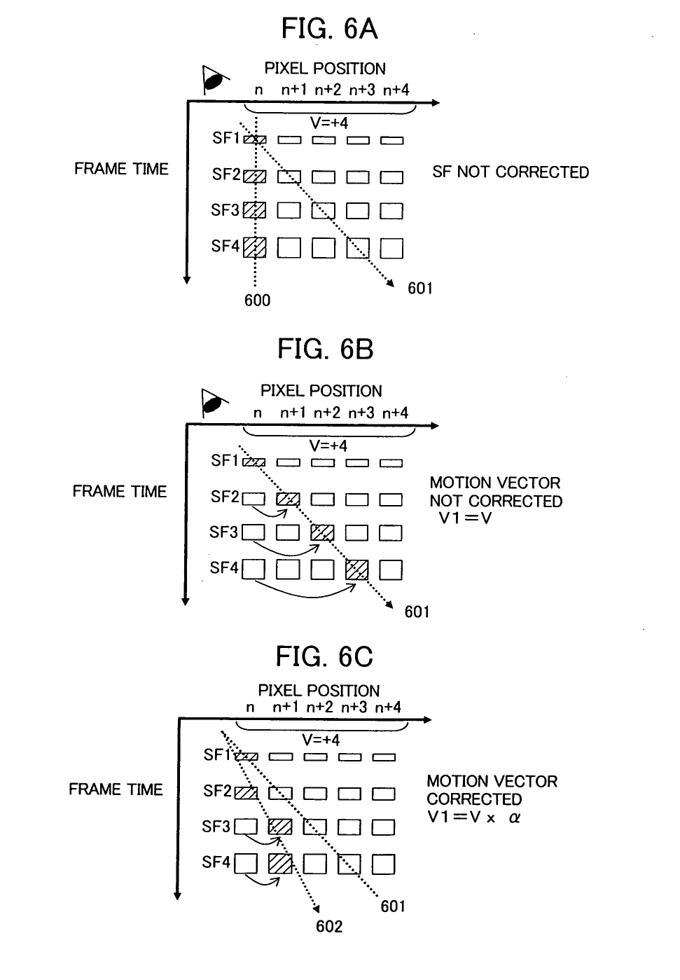

FIGS. 6A, 6B, and 6C show examples of the sub-field correction performed by the sub-field correction section 16. FIG. 6A is an example of no correction on sub-fields for comparison with the other examples. FIG. 6B is an example of correcting sub-fields without correcting the motion vector. FIG. 6C is an example of correcting sub-fields using the corrected motion vector. Horizontal pixel positions are shown horizontally. The frame time is shown vertically. Sub-fields SF1 through SF4 for pixels n through n+4 are shown in black when turned on and in white when turned off.

FIG. 6A illustrates no sub-field correction. Sub-fields for pixel n light along a line 600 for pixel n as an unchanged original position. This causes no problem when a still picture is displayed with the motion vector V set to 0. However, an observer's line of sight is directed as indicated by a dotted arrow 601 when a moving image is displayed with the motion vector V set to +4. A dynamic false contour occurs because an eye follows lighting of sub-fields for the other peripheral pixels.

FIG. 6B corrects sub-fields without correcting the motion vector. This process is effective for the changeover flag F set to 1 or 4 and is applied to the output frame 4 in FIG. 2A, for example. Concerning the output frame 4, the changeover detection section 14 finds the display modes M (P)=60 Hz and M (N)=60 Hz, and the changeover flag F=1 (ON unchanged). Since the flag F is set to 1, the motion vector correction section 15 sets the motion vector V1 for each pixel to +4 (no correction). Using the V1 value, the sub-field correction section 16 follows the above-mentioned equation (2) to calculate the pixel position Xi (i=1 through 4) of the sub-fields and finds X1=0, X2=1, X3=2, and X4=3. FIG. 6B shows relocation of SF1 through SF4 in accordance with the calculated value Xi. The lighting pixels are positioned along the eye direction 601 to reduce a dynamic false contour or a moving image blur.

FIG. 6C corrects sub-fields using the corrected motion vector. This process is effective for the changeover flag F set to 2 or 3 and is applied to the output frame 2a in FIG. 2A, for example. Concerning the output frame 2a, the changeover detection section 14 finds the display modes M (P)=24 Hz and M(N)=24 Hz, and the changeover flag F=2 (OFF unchanged). Since the flag F is set to 2, the motion vector correction section 15 corrects the motion vector V1 for each pixel using the calculation in accordance with the above-mentioned equation (1). Given that attenuation coefficient α=0.5, V1 is calculated as 4×0.5=+2. Using V1=+2, the sub-field correction section 16 follows the above-mentioned equation (2) to calculate the pixel position Xi (i=1 through 4) of the sub-fields and finds X1=0, X2=0, X3=1, and X4=1. The decimal part is truncated. FIG. 6C shows relocation of SF1 through SF4 in accordance with the calculated value Xi. The lighting pixels are positioned along a direction 602 that requires a smaller eye movement than the eye direction 601. The sub-field correction amount decreases. It is possible to reduce a dynamic false contour or a moving image blur without emphasizing the motion judder.

The embodiment varies the sub-field correction amount in accordance with the conversion mode (ON or OFF) of the frame rate conversion (FRC). It is possible to reduce a dynamic false contour or a moving image blur from a converted display image without emphasizing the motion judder that may occur when the FRC is turned off.

### Second Embodiment

The image display apparatus according to the second embodiment has the same configuration as that shown in FIG. 1 according to the first embodiment except that operations of the motion vector correction section 15 are changed. When the frame rate conversion (FRC) changes its conversion mode from ON (first conversion mode) to OFF (second conversion mode) or from OFF to ON, an image motion may become discontinuous before and after the mode change and the image may oscillate. To solve this problem, the motion vector correction section 15 according to the second embodiment performs the correction so as to smooth a motion vector change when the FRC mode changes.

The sub-field correction section 16 relocates sub-fields using the corrected motion vector. Specifically, the motion vector correction section 15 assumes the correction (V×α) using the equation (1) to be correction amount 100%. The motion vector correction section 15 further adjusts the correction amount using an adjustment factor β to find the motion vector V1. For example, the calculation uses the following equation (3).

V1=V×(1−β)+(V×α)×β (3)

For example, adjustment factor β=0.5 (correction amount=50%) is used when V1 is found as an average of V before the correction and the 100% correction value (V×α). Given α=0.5, the calculation follows.

V1=0.5 V+0.25 V=0.75 V

The adjustment factor β may be selected from the range 0<β<1 for weighted averaging.

When the FRC mode changes from OFF to ON, the sub-field correction amount can be gradually increased from 0.5 V to 0.75 V, and then V. When the FRC mode changes from ON to OFF, the sub-field correction amount can be gradually decreased from V to 0.75 V, and then 0.5 V. There is provided an effect of reducing image oscillation.

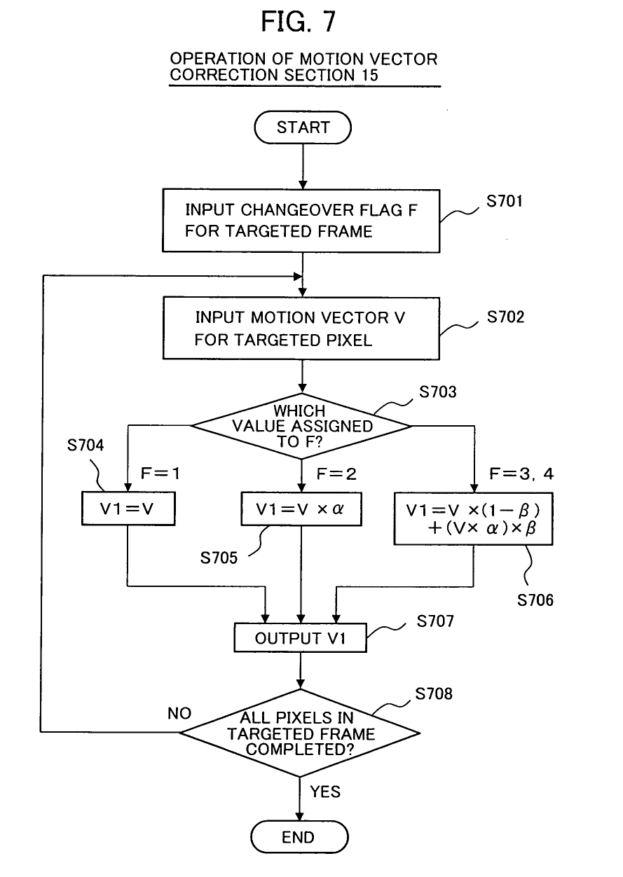

FIG. 7 is a flow chart showing an operation of the motion vector correction section 15.

At S701, the motion vector correction section 15 is supplied with the changeover flag F found by the changeover detection section 14 for the targeted frame. At S702, the motion vector correction section 15 is supplied with the motion vector V found by the motion vector detection section 11 for the targeted pixel. At S703, the motion vector correction section 15 measures a value of the changeover flag F.

When the changeover flag F is set to 1 (FRC remains ON), the motion vector correction section 15 proceeds to S704 and assumes the correction vector V1 to be V and does not correct the motion vector. When the changeover flag F is set to 2 (FRC remains OFF), the motion vector correction section 15 proceeds to S705 and finds a new motion vector V1 using the equation (1). When the changeover flag F is set to 3 or 4 (FRC changes from ON to OFF or from OFF to ON), the motion vector correction section 15 proceeds to S706 and finds the motion vector V1 using the equation (3).

At S707, the motion vector correction section 15 outputs the corrected motion vector V1 to the sub-field correction section 16. The motion vector correction section 15 proceeds to S708 and repeats S702 through S707 until all the pixels in the targeted frame are corrected.

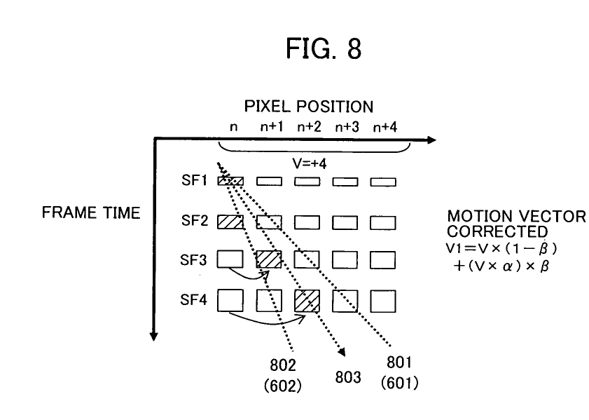

FIG. 8 shows an example of the sub-field correction performed by the sub-field correction section 16. The example shows the sub-field correction using the motion vector corrected with the attenuation coefficient a and the adjustment factor β in accordance with the above-mentioned equation (3). The process uses the changeover flag F set to 3 or 4 (changing the FRC) and is applied to the output frame 3 in FIG. 2A or the output frame 16a in FIG. 2B, for example.

Concerning the output frame 3, the changeover detection section 14 finds the display modes M(P)=24 Hz and M(N)=60 Hz, and the changeover flag F=4 (changing from OFF to ON). When the flag F is set to 4, the motion vector correction section 15 uses the above-mentioned equation (3) for calculation and finds the following based on attenuation coefficient α=0.5 and adjustment factor β=0.5.

V1=4×(1−0.5)+(4×0.5)×0.5=+3

Using this V1, the sub-field correction section 16 follows the above-mentioned equation (2) to calculate the pixel position Xi (i=1 through 4) of the sub-fields and finds X1=0, X2=0, X3=1, and X4=2. The decimal part is truncated. FIG. 8 shows relocation of SF1 through SF4 in accordance with the calculated value Xi along a direction 803. The relocation direction 803 is an intermediate between the relocation directions 801 (601) and 802 (602) for the preceding and subsequent output frames 2b and 4 as shown in FIGS. 6B and 6C. The sub-fields can be relocated so as to gradually increase when the FRC is changed.

Similarly, the FRC is changed from ON to OFF for the output frame 16a in FIG. 2B. The sub-field relocation direction is an intermediate between those for the output frames 15 and 16b. The sub-fields can be relocated so as to gradually decrease.

When the FRC is changed, it is possible to reduce image oscillation as well as a moving image blur or a dynamic false contour.

The embodiment uses the factor β to adjust the correction amount of sub-fields in only one frame when the FRC is changed. The same effect also results by using the factor β to adjust several frames before and after the FRC change.

Similarly to the first embodiment, the second embodiment can reduce both a moving image blur and a dynamic false contour without emphasizing the motion judder. In addition, the embodiment can reduce image oscillation that occurs when the frame rate conversion mode changes between ON and OFF.

### Third Embodiment

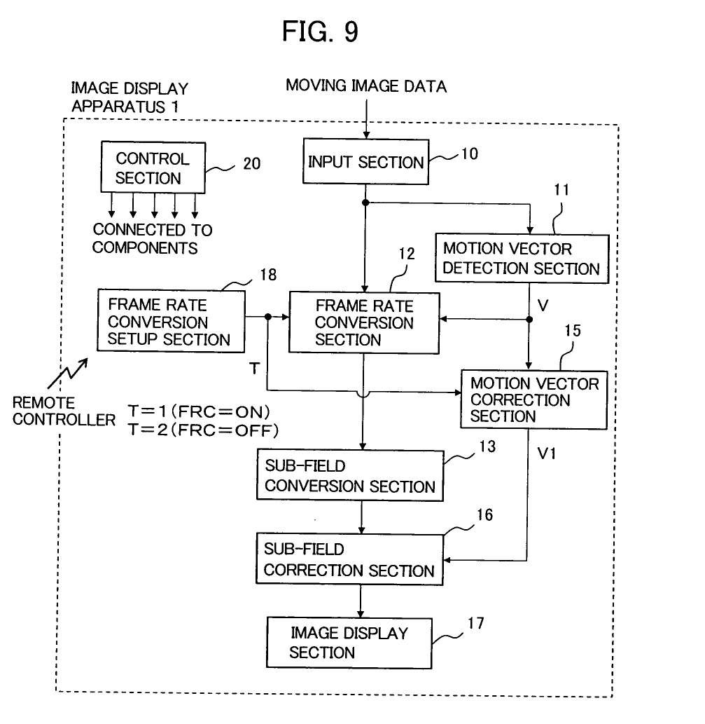

FIG. 9 is a block diagram of the image display apparatus according to the third embodiment of the invention. The image display apparatus 1 according to the third embodiment is compliant with a modification of the configuration of FIG. 1 according to the first embodiment by removing the changeover detection section 14 and newly adding a frame rate conversion setup section 18.

The frame rate conversion setup section 18 is equivalent to one of television screen setup menus. The frame rate conversion setup section 18 allows a user to specify the frame rate conversion (FRC) mode ON or OFF using a remote controller. FRC setup value T is set to 1 when FRC=ON (first conversion mode) is selected. FRC setup value T is set to 2 when FRC=OFF (second conversion mode) is selected.

According to the FRC setup value T, the frame rate conversion section 12 changes the conversion operation, creates an interpolation frame, and outputs it. The information about the FRC setup value T is input to the motion vector correction section 15 and is used for the motion vector correction. Therefore, the changeover detection section 14 according to the first embodiment (FIG. 1) is unneeded. The motion vector correction section 15 corrects the motion vector V detected by the motion vector detection section 11. When FRC=ON is selected (T=1), the motion vector correction section 15 outputs the correction vector V1=V (first correction). When FRC=OFF is selected (T=2), the motion vector correction section 15 outputs the corrected vector V1=V×α (second correction) in accordance with the equation (1). The sub-field correction section 16 uses the correction vector V1 to relocate the sub-fields.

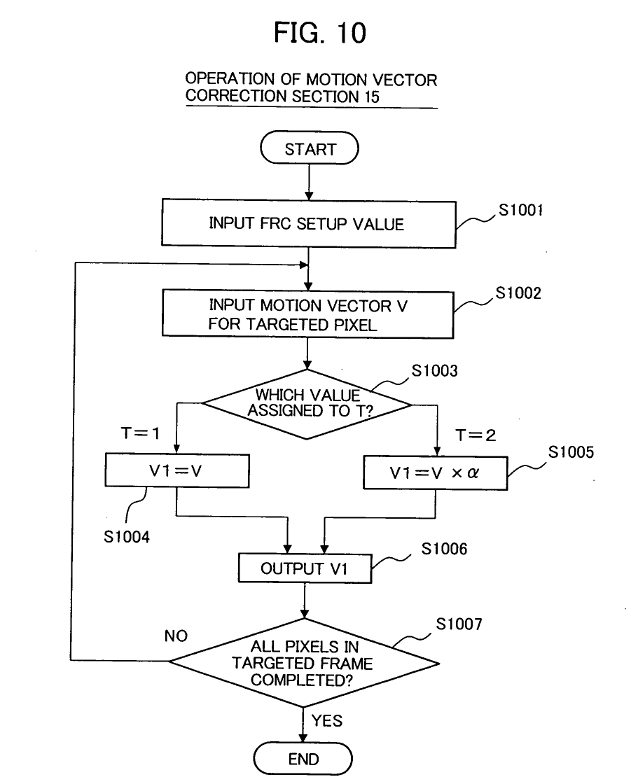

FIG. 10 is a flow chart showing an operation of the motion vector correction section 15 in FIG. 9.

At S1001, the motion vector correction section 15 is supplied with the FRC setup value T configured by the frame rate conversion setup section 18. At S1002, the motion vector correction section 15 is supplied with the motion vector V found by the motion vector detection section 11 for the targeted pixel. At S1003, the motion vector correction section 15 determines the FRC setup value T.

When the FRC setup value T is set to 1 (FRC activated), the motion vector correction section 15 proceeds to S1004, assumes the correction vector V1 to be V, and does not correct the motion vector. When the FRC setup value T is set to 2 (FRC inactivated), the motion vector correction section 15 proceeds to S1005 and finds a new motion vector V1 in accordance with the equation (1).

At S1006, the motion vector correction section 15 outputs the corrected motion vector V1 to the sub-field correction section 16. The motion vector correction section 15 proceeds to S1007 and repeats S1002 through S1006 until all the pixels in the targeted frame are corrected.

As a result, the sub-field correction section 16 relocates the sub-fields similarly to FIGS. 6A through 6C, for example. When the FRC is performed, the frames in FIG. 6A are relocated as shown in FIG. 6B. When the FRC is not performed, the frames in FIG. 6A are relocated as shown in FIG. 6C. Accordingly, inactivating the FRC can decrease the correction amount of sub-fields.

Similarly to the first embodiment, the third embodiment can reduce a moving image blur or a dynamic false contour from an image display after the frame rate conversion without emphasizing the motion judder. In addition, the embodiment can allow a user to select the frame rate conversion mode ON or OFF, improving the usability.

### Fourth Embodiment

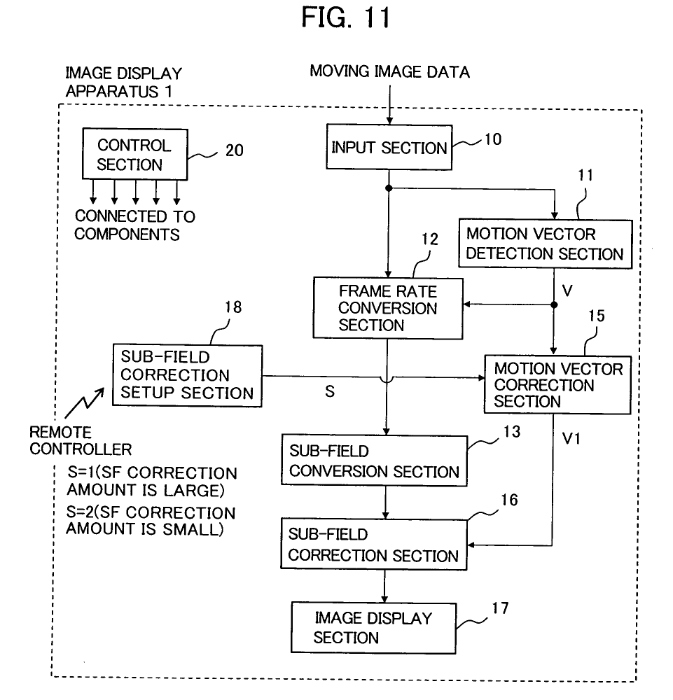

FIG. 11 is a block diagram showing the image display apparatus according to the fourth embodiment of the invention. The image display apparatus 1 according to the fourth embodiment is compliant with a modification of the configuration of FIG. 1 according to the first embodiment by removing the changeover detection section 14 and newly adding a sub-field correction setup section 19.

The sub-field correction setup section 19 is equivalent to one of television screen setup menus. The sub-field correction setup section 19 allows a user to specify a large or small value for the sub-field (SF) correction amount using a remote controller, for example. When a large value is assigned to the SF correction amount, the sub-field correction setup section 19 sets SF correction setup value S to 1. When a small value is assigned to the SF correction amount, the sub-field correction setup section 19 sets SF correction setup value S to 2. Based on the SF correction setup value S, the motion vector correction section 15 corrects the motion vector. Therefore, the changeover detection section 14 according to the first embodiment (FIG. 1) is unneeded.

The motion vector correction section 15 corrects the motion vector V detected by the motion vector detection section 11. When a large value is assigned to the SF correction amount (S=1), the motion vector correction section 15 outputs the correction vector V1=V (first correction). When a small value is assigned to the SF correction amount (S=2), the motion vector correction section 15 outputs the corrected vector V1=V×α (second correction) in accordance with the equation (1). These values are independent of the frame rate conversion ON or OFF determined by the frame rate conversion section 12. The sub-field correction section 16 uses the correction vector V1 to relocate the sub-fields.

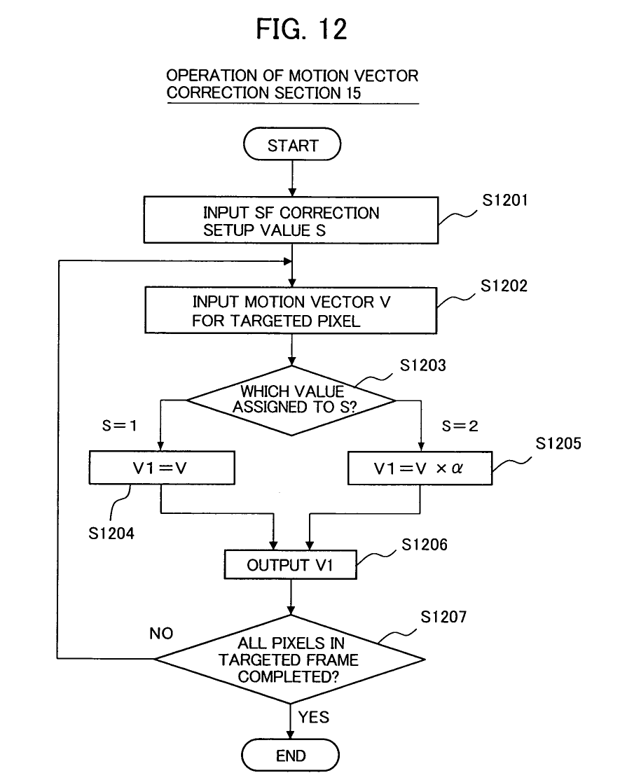

FIG. 12 is a flow chart showing an operation of the motion vector correction section 15 in FIG. 11.

At S1201, the motion vector correction section 15 is supplied with the SF correction setup value S configured by the sub-field correction setup section 19. At S1202, the motion vector correction section 15 is supplied with the motion vector V found by the motion vector detection section 11 for the targeted pixel. At S1203, the motion vector correction section 15 determines the SF correction setup value S.

When the SF correction setup value S is set to 1 (large SF correction amount), the motion vector correction section 15 proceeds to S1204, assumes the correction vector V1 to be V, and does not correct the motion vector. When the SF correction setup value S is set to 2 (small SF correction amount), the motion vector correction section 15 proceeds to S1205 and finds a new motion vector V1 in accordance with the equation (1).

At S1206, the motion vector correction section 15 outputs the corrected motion vector V1 to the sub-field correction section 16. The motion vector correction section 15 proceeds to S1207 and repeats S1202 through S1206 until all the pixels in the targeted frame are corrected.

As a result, the sub-field correction section 16 relocates the sub-fields similarly to FIGS. 6A through 6C, for example. The frames in FIG. 6A are relocated as shown in FIG. 6B when a large SF correction amount is specified. The frames in FIG. 6A are relocated as shown in FIG. 6C when a small SF correction amount is specified. Accordingly, configuring the SF correction setup value S can decrease the correction amount of sub-fields.

The above-mentioned example uses two choices 1 and 2 to be assigned to the SF correction setup value S. Three or more choices may be available when multiple attenuation coefficients a are provided.

The fourth embodiment can reduce a dynamic false contour or a moving image blur from an image display after the frame rate conversion. In addition, the embodiment can allow a user to configure the sub-field correction amount, improving the usability.

The above-mentioned embodiments effectively prevent image quality degradation. The embodiments provide the following specific effects.

The first embodiment can change the sub-field correction amount in accordance with the ON/OFF state of the frame rate conversion (FRC). The embodiment can prevent a video interpolated by the FRC from generating a moving image blur or a dynamic false contour. The embodiment can reduce both the moving image blur and the dynamic false contour without emphasizing motion judder for frames that remain unchanged before and after the conversion.

The second embodiment can reduce image oscillation when the FRC is automatically changed. In addition, the embodiment can reduce a moving image blur or a dynamic false contour from a frame interpolated by the FRC. The embodiment can reduce both the moving image blur and the dynamic false contour without emphasizing motion judder for frames that remain unchanged before and after the conversion.

The third embodiment can change the sub-field correction amount in accordance with a user-specified setup value T that determines whether or not to perform the FRC. The embodiment can reduce a moving image blur or a dynamic false contour from a frame interpolated by the FRC. The embodiment can reduce both the moving image blur and the dynamic false contour without emphasizing motion judder for frames that remain unchanged before and after the conversion.

The fourth embodiment can change the sub-field correction amount in accordance with a user-specified correction amount setup value S for the SF correction. The embodiment can control the amount of decrease in the moving image blur or the dynamic false contour for all frames in accordance with user preferences.

The above-mentioned embodiments can be modified as follows.

Although an example of frame rate conversions of 24 Hz and 60 Hz has been taken up above, the embodiments are applicable to the other frame rate conversions such as 50 Hz and 60 Hz, 30 Hz and 60 Hz, 25 Hz and 50 Hz, and the like and provide the same effect.

The motion vectors have been described using one-dimensional values corresponding to only horizontal movement as an example. Two-dimensional values may be also used. The number of sub-fields N has been described as four but is not limited thereto.

The embodiments of the invention may be equivalent to any combinations of the above-mentioned examples of drawings or methods.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications that fall within the ambit of the appended claims.

What is claimed is:

1. An image display apparatus that time-shares an image frame created by frame rate conversion into a plurality of sub-fields and displays luminescent data in the sub-fields, the image display apparatus comprising:
a motion vector detection section that detects motion vector V0 for a pixel between frames of an input image and finds motion vector V for a pixel between frames whose frame rates are converted using the motion vector V0;
a frame rate conversion section that converts a frame rate for the input image into a frame rate for image display using a first conversion mode or a second conversion mode, wherein the first conversion mode creates an interpolation image using the motion vector V0 or V and the second conversion mode repeatedly outputs the input image;
a sub-field conversion section that converts each frame of an image having the converted frame rate into luminescent data for the plurality of sub-fields;
a changeover detection section that detects one of the first and second conversion modes performed by the frame rate conversion section;
a motion vector correction section that corrects a motion vector V found by the motion vector detection section to a motion vector V1 in accordance with a conversion mode detected by the changeover detection section;
a sub-field correction section that relocates luminescent data for the sub-fields converted by the sub-field conversion section using the corrected motion vector V1; and
an image display section that displays an image using the luminescent data for the sub-fields relocated by the sub-field correction section,
wherein the motion vector correction section assumes the motion vector V to be the corrected motion vector V1 as is when the changeover detection section detects the first conversion mode; and
wherein the motion vector correction section corrects a motion vector according to V1=V×α, where 0≦α<1, when the changeover detection section detects the second conversion mode.

2. The image display apparatus according to claim 1,
wherein the changeover detection section further detects whether there is a change between the first conversion mode and the second conversion mode performed by the frame rate conversion section;
wherein, when the changeover detection section detects a conversion mode change, the motion vector correction section corrects a motion vector for an image corresponding to the conversion mode change using
V1=V×(1−β)+(V×α)×β, where 0<β<1.

3. An image display apparatus that time-shares an image frame created by frame rate conversion into a plurality of sub-fields and displays luminescent data in the sub-fields, the image display apparatus comprising:
a motion vector detection section that detects motion vector V0 for a pixel between frames of an input image and finds motion vector V for a pixel between frames whose frame rates are converted using the motion vector V0;
a frame rate conversion section that converts a frame rate for the input image into a frame rate for image display using a first conversion mode or a second conversion mode, wherein the first conversion mode creates an interpolation image using the motion vector V0 or V and the second conversion mode repeatedly outputs the input image;
a sub-field conversion section that converts each frame of an image having the converted frame rate into luminescent data for the plurality of sub-fields;
a motion vector correction section that corrects a motion vector V found by the motion vector detection section to a motion vector V1;
a sub-field correction section that relocates luminescent data for the sub-fields converted by the sub-field conversion section using the corrected motion vector V1 to; and
an image display section that displays an image using the luminescent data for the sub-fields relocated by the sub-field correction section,
wherein the motion vector correction section selects one of first correction and second correction;
wherein the first correction assumes the motion vector V to be the corrected motion vector V1 as is; and
wherein the second correction finds a motion vector V1 using V1=V×α, where 0≦α<1.

4. The image display apparatus according to claim 3, comprising:
a frame rate conversion setup section that enables one of the first and second conversion modes as a conversion mode to be performed by the frame rate conversion section,
wherein the motion vector correction section selects the first correction when the frame rate conversion setup section enables the first conversion mode; and
wherein the motion vector correction section selects the second correction and finds a motion vector V1 when the frame rate conversion setup section enables the second conversion mode.

5. The image display apparatus according to claim 3, comprising:
a sub-field correction setup section that provides a correction amount for the sub-field correction section to relocate luminescent data,
wherein the motion vector correction section selects the first correction when the sub-field correction setup section provides a large correction amount; and
wherein the motion vector correction section selects the second correction and finds a motion vector V1 when the sub-field correction setup section provides a small correction amount.

6. An image display method of time-sharing an image frame created by frame rate conversion into a plurality of sub-fields and displaying luminescent data in the sub-fields, the image display method comprising the steps of:
(a) detecting motion vector V0 for a pixel between frames of an input image and finding motion vector V for a pixel between frames whose frame rates are converted using the motion vector V0;
(b) converting a frame rate for the input image into a frame rate for image display using a first conversion mode or a second conversion mode, wherein the first conversion mode creates an interpolation image using the motion vector V0 or V and the second conversion mode repeatedly outputs the input image;
(c) converting each frame of an image having the converted frame rate into luminescent data for the plurality of sub-fields;
(d) detecting one of the first and second conversion modes performed at the step (b);
(e) correcting a motion vector V found at the step (a) to a motion vector V1 in accordance with a conversion mode detected at the step (d);
(f) relocating luminescent data for the sub-fields converted at the step (c) using the corrected motion vector V1; and
(g) displaying an image using the luminescent data for the sub-fields relocated at the step (f),
wherein the step (e) assumes the motion vector V to be the corrected motion vector V1 as is when the step (d) detects the first conversion mode; and
wherein the step (e) corrects a motion vector according to V1=V×α, where 0≦α<1, when the step (d) detects the second conversion mode.

7. The image display method according to claim 6,
wherein the step (d) further detects whether there is a change between the first conversion mode and the second conversion mode performed at the step (b);
wherein, when the step (d) detects a conversion mode change, the step (e) corrects a motion vector for an image corresponding to the conversion mode change using
V1=V×(1−β)+(V×α)×β, where 0<β<1.

8. An image display method of time-sharing an image frame created by frame rate conversion into a plurality of sub-fields and displaying luminescent data in the sub-fields, the image display method comprising the steps of:
(a) detecting motion vector V0 for a pixel between frames of an input image and finding motion vector V for a pixel between frames whose frame rates are converted using the motion vector V0;
(b) converting a frame rate for the input image into a frame rate for image display using a first conversion mode or a second conversion mode, wherein the first conversion mode creates an interpolation image using the motion vector V0 or V and the second conversion mode repeatedly outputs the input image;
(c) converting each frame of an image having the converted frame rate into luminescent data for the plurality of sub-fields;
(d) correcting a motion vector V found at the step (a) to a motion vector V1;
(e) relocating luminescent data for the sub-fields converted at the step (c) using the corrected motion vector V1; and
(f) displaying an image using the luminescent data for the sub-fields relocated at the step (e),
wherein the step (d) selects one of first correction and second correction;
wherein the first correction assumes the motion vector V to be the corrected motion vector V1 as is; and
wherein the second correction finds a motion vector V1 using V1=V×α, where 0≦α<1.

9. The image display method according to claim 8, comprising the step of:
(g) enabling one of the first and second conversion modes as a conversion mode to be performed at the step (b),
wherein the step (d) selects the first correction when the step (g) enables the first conversion mode; and
wherein the step (d) selects the second correction and finds a motion vector V1 when the step (g) enables the second conversion mode.

10. The image display method according to claim 8, comprising the step of:
(h) providing a correction amount for the step (e) to relocate luminescent data,
wherein the step (d) selects the first correction when the step (h) provides a large correction amount; and
wherein the step (d) selects the second correction and finds a motion vector V1 when the step (h) provides a small correction amount.
